(19) United States
(12) Patent Application Publication
(10) Pub. No.: US 2002/0190818 A1
(43) Pub. Date: Dec. 19, 2002

(54) High frequency band pass filter

(76) Inventors: Kenji Endou, Tokyo (JP); Toshiaki Yamada, Tokyo (JP)

Correspondence Address: BROWN RAYSMAN MILLSTEIN FELDER & STEINER, LLP, SUITE 711, 1880 CENTURY PARK EAST, LOS ANGELES, CA, 90067, US

(21) Appl. No.: 09/963,024

(22) Filed: Sep. 24, 2001

(30) Foreign Application Priority Data
Sep. 25, 2000 (JP) 2000-290806

(51) Int. Cl. H01P 1/205

(52) U.S. Cl. 333/202; 333/206

(57) ABSTRACT

A high frequency band pass filter using a high frequency multilayered substrate is provided that does not experience interlayer shift during lamination, requires only a small number of printings, does not shrink during firing, avoids distortion in the shape, thickness and spacing of substrate internal patterns and in the location of the internal pattern of the discrete devices after dicing, is free from burr occurrence, is excellent in dicing efficiency during fabrication, is superior in product yield and cost, and has enhanced performance.

A high frequency band pass filter includes a dielectric block 2 of substantially rectangular prismatic shape having a plurality of through holes 5 formed from one surface thereof to another surface opposite the one surface and having metallizations formed on all outer surfaces except the one surface and all inner surfaces of the holes, and a dielectric multilayered substrate having a plurality of dielectric layers 3a-3f and incorporating capacitors and/or inductors. The dielectric multilayered substrate is made of a resin multilayered substrate and the dielectric layers are made from a composite dielectric material composition including a ceramic dielectric material and a heat-resistant, low-dielectric polymeric material including one or more resins whose weight-average absolute molecular weight is at least 1,000 and wherein the sum of carbon atoms and hydrogen atoms is at least 99% of all atoms and some or all resin molecules have a chemical bond therebetween.

### BACKGROUND OF THE INVENTION

The present invention relates to a high frequency band pass filter used as a microwave band or millimeter wave band electronic component in mobile phones and other mobile telecommunications devices, and more particularly to a high frequency band pass filter using a high frequency multilayered substrate that does not experience interlayer shift during lamination, requires only a small number of printings, does not shrink during firing, avoids distortion in the shape, thickness and spacing of substrate internal patterns and in the location of the internal pattern of the discrete devices after dicing, is free from burr occurrence, is excellent in dicing efficiency during fabrication, is superior in product yield and cost, and has enhanced performance.

2. Description of the Prior Art

In general, a dielectric block having through holes passing from one surface to the opposite surface and all of whose surfaces except said one surface are metallized is used as a high frequency band pass filter. The through holes formed on the dielectric block work as resonators for the high frequency signal. The band pass filter circuit is formed by adding capacitance and so forth to the resonators.

Many proposals have been made regarding methods for adding capacitance and so forth to the resonators constituted by the through holes.

According to one such method the dielectric block with the through holes is mounted on a substrate and the capacitors etc. are added to the substrate as separate components to form the band pass filter circuit. This method has the advantage that complex processing of the dielectric block is not required but has the disadvantage that the overall circuit size is enlarged because numerous components are used. The method is therefore not suitable for application to equipment that requires miniaturization, such as mobile phones.

According to another proposed method, conductive patterns that work as capacitors etc. are formed on said one surface of the dielectric block by screen-printing to form the band pass filter circuit This method has the advantage that overall circuit size can be reduced because no capacitors etc. are added as separate components, but has the disadvantage that it is difficult to form the conductive patterns because they are extremely fine.

In still another method, grooves or cavities are formed on said one surface of the dielectric block to form the band pass filter circuit by intentionally disrupting the electromagnetic field coupling distribution balance to establish magnetic field or electric field coupling. This method also has the advantage that overall circuit size can be reduced because addition of separate components like capacitors is unnecessary but has the disadvantage that it increases fabricating cost because it is difficult to fabricate a die for the dielectric block and the die must be custom-made for each type of band pass filter. This method has the further disadvantage that it degrades yield because the strength of the dielectric block is lowered.

Against this backdrop, a filter component incorporating a ceramic dielectric resonator has been proposed in which the load elements, grooves, open end conductive pattern and other functional elements are formed in a ceramic multilayer substrate and the SMD terminals are also formed on the substrate (see, for example, Japanese Patent Application No.3-35490, Japanese Patent Application No. 9-120251 and Japanese Patent Application No.9-221102).

The ceramic multilayer substrate for such components is fabricated by forming the conductive patterns for several to several hundreds of filters on ceramic, firing the ceramic to form a single substrate, and then dicing the single substrate to obtain a plurality of discrete products.

When the conductive patterns are formed by printing layers of conductive paste on ceramic green sheets and laminating the sheets, however, interlayer shift is liable to occur during lamination. When the multilayer printing method of printing with the ceramic also in the form of paste is adopted, a large number of printings are required.

Whichever method is used, distortion in the shape, thickness and spacing of the pattern and in the location of the internal pattern of discrete devices after dicing is liable to occur because shrinkage of 10% or more ordinarily arises during firing. As this makes it extremely difficult to ensure uniformity among the discrete products, low yield, high cost and poor performance become a problem.

Further, in the step dicing the substrate to obtain discrete products, the shape of the products may be distorted if the dicing of the substrate is performed before firing. On the other hand, if the dicing of the substrate is performed after firing by using snaps formed prior to firing, burrs may be formed. Moreover, in case of dicing the substrate after firing, the dicing efficiency is not good because the fired ceramic is hard.

In view of foregoing, glass-epoxy and other resin-based substrates have been proposed to replace the ceramic substrate. In recent years, resin substrates made from BT resin, PPO and the like have come into use for high frequency devices. However, these have the drawback that the substrate's dielectric loss tangent (tan δ) at high frequency is 0.03 to 0.05 or more, which is very high compared with the 0.001 or lower dielectric loss tangent of a ceramic.

### SUMMARY OF THE INVENTION

It is therefore an object of the present invention to provide a high frequency band pass filter using a multilayered substrate that does not experience interlayer shift during lamination, requires only a small number of printings, does not shrink during firing, avoids distortion in the shape, thickness and spacing of substrate internal patterns and in the location of the internal pattern of the discrete devices after dicing, is free from burr occurrence, is excellent in dicing efficiency during fabrication, is superior in product yield and cost, and has enhanced performance.

The above and other objects of the present invention can be accomplished by a high frequency band pass filter comprising a metallized dielectric block of substantially rectangular prismatic shape having a plurality of through holes formed from one surface thereof to another surface opposite the one surface and having metallizations formed on all outer surfaces except the one surface and all inner surfaces of the holes and a dielectric multilayered substrate having a plurality of dielectric layers and incorporating a capacitor and/or inductor, the dielectric multilayered substrate being made of a resin multilayered substrate, the dielectric layers being made from a composite dielectric material composition including a ceramic dielectric material and a heat-resistant, low-dielectric polymeric material including one or more resins whose weight-average absolute molecular weight is at least 1,000 and wherein the sum of carbon atoms and hydrogen atoms is at least 99% of all atoms and some or all resin molecules have a chemical bond therebetween.

Since the dielectric layers are made from the composite dielectric material composition in the present invention, dicing for obtaining discrete chips is easy, interlayer shift during lamination is avoided, and the number of required printings is reduced.

Since the dielectric layers are made from the composite dielectric material composition in the present invention, shrinkage during firing is avoided and distortion in the shape, thickness, spacing and location of the internal patterns of the discrete products after dicing is avoided.

Since the dielectric layers are made from the composite dielectric material composition in the present invention, the high frequency band pass filter has no burrs, is superior in dicing efficiency during fabrication, and can be fabricated with excellent product yield and at low cost.

In a preferred aspect of the present invention, input/output electrodes are formed on the dielectric multilayered substrate.

In a further preferred aspect of the present invention, the dielectric multilayered substrate is covered with metallizations formed on substantially all surfaces except a surface opposite to the dielectric block and peripheral portions of the input/output electrodes.

In a further preferred aspect of the present invention, the heat-resistant, low-dielectric polymeric material has at least one bond selected from among crosslinking, block and graft structure.

In a further preferred aspect of the present invention, the heat-resistant, low-dielectric polymeric material is a copolymer in which a non-polar α-olefin base polymer segment and/or a nonpolar conjugated diene base polymer segment are chemically combined with a vinyl aromatic polymer segment and is a thermoplastic resin exhibiting a multiphase structure wherein a dispersion phase formed by one segment is finely dispersed in a continuous phase formed by the other segment.

In a further preferred aspect of the present invention, the heat-resistant, low-dielectric polymeric material is a copolymer composed of the non-polar α-olefin base copolymer segment chemically combined with the vinyl-aromatic polymer segment.

In a further preferred aspect of the present invention, the heat-resistant, low-dielectric polymeric material is a copolymer composed of 5 to 9.5% by weight of the non-polar α-olefin base polymer segment chemically combined with 95 to 5% by weight of the vinyl aromatic polymer segment.

In a further preferred aspect of the present invention, the heat-resistant, low-dielectric polymeric material is a copolymer composed of 40 to 90% by weight of the non-polar α-olefin base polymer segment chemically combined with 60 to 10% by weight of the vinyl aromatic polymer segment.

In a further preferred aspect of the present invention, the heat-resistant, low-dielectric polymeric material is a copolymer composed of 50 to 80% by weight of the non-polar α-olefin base polymer segment chemically combined with 50 to 20% by weight of the vinyl aromatic polymer segment.

In a further preferred aspect of the present invention, the vinyl aromatic polymer segment is a vinyl aromatic copolymer segment containing a monomer of divinylbenzene.

In a further preferred aspect of the present invention, the heat-resistant, low-dielectric polymeric material is copolymer wherein the non-polar α-olefin base polymer segment and/or the nonpolar conjugated diene base polymer segment are chemically combined with the vinyl aromatic polymer segment by graft polymerization.

In a further preferred aspect of the present invention, the heat-resistant, low-dielectric polymeric material further comprises a non-polar α-olefin base polymer containing a monomer of 4-methylpentene-1.

In a further preferred aspect of the present invention, the dielectric multilayered substrate is obtained by dicing from a large multilayered body and comprises conductive layers in addition to the dielectric layers, and the heat-resistant, low-dielectric polymeric material is obtained by polymerizing a monomer composition containing as monomer at least a monomer of fumaric diester.

In a further preferred aspect of the present invention, the fumaric diester is expressed by structural formula (I):

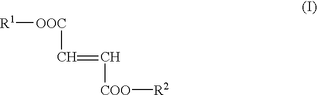

where R¹ indicates an alkyl group or a cycloalkyl group; R² indicates an alkyl group, a cycloalkyl group or an aryl group; and R¹ and R² can be the same or different.

In a further preferred aspect of the present invention, the monomer composition further includes a vinyl group monomer expressed by structural formula (II):

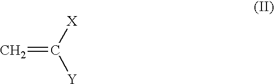

where X indicates a hydrogen atom or a methyl group; and Y indicates a fluorine atom, a chlorine atom, an alkyl group, an alkenyl group, an aryl group, an ether group, an acyl group or an ester group.

### BRIEF DESCRIPTION OF THE DRAWINGS

FIG. 1 is an exploded schematic perspective view showing a high frequency band pass filter that is a preferred embodiment of the present invention.

FIG. 2 is a schematic perspective view showing the high frequency band pass filter with its components joined.

FIG. 3 is an equivalent circuit diagram of the filter shown in FIGS. 1 and 2.

FIG. 4 is a graph showing the transmission characteristic and the reflection characteristic in the range of 0.75 to 1 GHz of a high frequency band pass filter fabricated in a working sample.

### DESCRIPTION OF THE PREFERRED EMBODIMENT

A multilayered substrate used for the band pass filter of the present invention is diced from a large multilayered body. It is a high frequency multilayered component having dielectric layers and conductive layers. The dielectric layers are made from a heat-resistant, low-dielectric polymeric material and a ceramic dielectric material. The heat-resistant, low-dielectric polymeric material includes one or more resins whose weight-average absolute molecular weight is at least 1,000 and wherein the sum of carbon atoms and hydrogen atoms is at least 99% of all atoms and some or all resin molecules have a chemical bond therebetween.

By “large multilayered body” is meant a precursor (multilayered precursor) before dicing into discrete chips. The length, width and thickness of the large multilayered body are preferably 4 to 25 cm, 4 to 25 cm, and 0.02 to 0.5 cm, more preferably 4 to 12 cm, 4 to 12 cm, and 0.05 to 0.2 cm.

The multilayered precursor is fabricated by stacking dielectric layers and the conductive layers with the conductive layers placed at required locations on or between the dielectric layers and pressing the stack vertically. The pressure applied is preferably in the range of 3 to 10 kg/cm², more preferably 5 to 7 kg/cm². The multilayered precursor can be heated during the pressing. The heating temperature is normally 100 to 260° C., preferably 180 to 220° C.

The number of chips obtained by dicing the multilayered precursor depends on the shape of the chip but is ordinarily 10 to 5,000 chips, typically 20 to 500 chips.

The chips can be obtained by stamping the multilayered precursor or cutting it using a shearing machine, circular saw, band saw, abrasive cutting machine, ultrasonic machine or the like.

According to the present invention, the high frequency multilayered components can be obtained at a yield of at least 90%, typically 97% to 100%.

In the present invention, the dielectric layers are made from a heat-resistant, low-dielectric polymeric material and a ceramic dielectric material. The heat-resistant, low-dielectric polymeric material includes one or more resins whose weight-average absolute molecular weight is at least 1,000 and wherein the sum of carbon atoms and hydrogen atoms is at least 99% of all atoms and some or all resin molecules have a chemical bond therebetween.

Thanks to this structure of the dielectric layers, a high dielectric constant and low dielectric loss tangent can be obtained in the high frequency band.

In contrast, dielectric layers made from only the heat-resistant, low-dielectric polymeric material without using the ceramic dielectric material are so low in dielectric constant as not to be suitable for practical use.

The reason for specifying that the heat-resistant, low-dielectric polymeric material must contain one or more resins whose weight-average absolute molecular weight is at least 1,000 is to ensure superior strength, adhesion to metal and heat resistance. The reason for specifying that the sum of carbon atoms and hydrogen atoms of the one or more resins must be at least 99% of the total number of atoms is to ensure that the chemical bonding present is nonpolar bonding. This makes it easy to obtain a low dielectric loss tangent.

A weight-average absolute molecular weight smaller than 1,000 is undesirable because the mechanical and heat-resistance properties are degraded. Use of resin wherein the sum of carbon atoms and hydrogen atoms is less than 99% of all atoms, particularly, resin containing more than 1% of oxygen, nitrogen or other atoms that form polar molecules, is undesirable because the dielectric loss tangent markedly increases.

The weight-average absolute molecular weight is more preferably 3,000 or greater, and even more preferably 5,000 or greater. The upper limit of the weight-average absolute molecular weight is not particularly defined but is generally about 10,000,000. In case of a thermoplastic resin, however, it may be much larger than 10,000,000.

Examples of the resin forming the heat-resistant, low-dielectric polymeric material are homopolymers and copolymers (hereinafter often referred to generically as “(co)polymers)”) of non-polar α-olefins such as low-density polyethylene, ultra-low-density polyethylene, very-ultra-low-density polyethylene, high-density polyethylene, low-molecular-weight polyethylene, ultra-high molecular-weight polyethylene, ethylene-propylene copolymer, polypropylene, polybutene, and poly(4-methylpentene); (co)polymers of monomers of conjugated dienes such as butadiene, isoprene, pentadiene, hexadiene, heptadiene, octadiene, phenylbutadiene, and diphenylbutadiene; and (co)polymers of monomers of carbon ring-containing vinyl such as styrene, nucleus-substituted styrene, e.g., methylstyrene, dimethylstyrene, ethylstyrene, isopropylstyrene, and chlorostyrene, and a-substituted styrene, e.g., α-methystyrene, α-ethylstyrene, divinylbenzene, and vinylcyclohexane.

Resins usable for the heat-resistant, low-dielectric polymeric material include not only polymers between units of one single nonpolar α-olefin monomer, one single conjugated diene monomer and one single carbon ring-containing vinyl monomer. It is also acceptable to use polymers obtained from monomers of different chemical species, for instance, a nonpolar α-olefin monomer and a conjugated diene monomer, and a nonpolar α-olefin monomer and a carbon ring-containing vinyl monomer,

In the present invention, the resin composition is thus comprised of these polymers, i.e., one or more resins. However, it is then required that some or all resin molecules be chemically bonded with each other. In other words, some resin molecules may be in a mixed state.

Since at least some resin molecules are chemically bonded with each other, the resin composition, when used as a heat-resistant, low-dielectric polymeric material, ensures sufficient strength, sufficient adhesion to metals, and sufficient heat resistance. In contrast, the resin composition, when it is only in a mixed state and has no chemical bond, is insufficient in terms of heat resistance and mechanical properties.

Although not critical, the form of the chemical bond in the present invention may be a crosslinked structure, a block structure or a graft structure obtained by known methods. Preferred embodiments of graft and block structures will be given later. The crosslinked structure is preferably obtained by heating, preferably conducted at a temperature of the order of 50 to 300° C. The crosslinked structure can alternatively be formed by another method such as electron beam irradiation.

The presence or absence of the chemical bond can be identified by determining the degree of crosslinking, and graft efficiency, etc. in the case of the graft structure. It can also be confirmed from transmission electron microscope (TEM) photographs or scanning electron microscope (SEM) photographs. Ordinarily, one polymer segment is dispersed in the other polymer segment in the form of fine particles of up to approximately 10 μm, and more specifically 0.01 to 10 μm. In a simple mixture (polymer blend), on the contrary, no compatibility like that between polymers in a graft copolymer is observed so that the dispersed particles are large.

As a first preferred example of the heat-resistant, low-dielectric polymeric material (resin composition) of the invention there can be mentioned a thermoplastic resin that is a copolymer in which a non-polar α-olefin base polymer segment is chemically combined with a vinyl aromatic copolymer segment, and which exhibits a multiphase structure in which a dispersion phase formed by one segment is finely dispersed in a continuous phase formed by the other segment.

The non-polar α-olefin base polymer that is one segment in the thermoplastic resin exhibiting such a specific multiphase structure is required to be either a homopolymer of units of one single non-polar α-olefin monomer or a copolymer of two or more non-polar α-olefin polymers, obtainable by high-pressure radical polymerization, moderate or low-pressure ion polymerization, etc. Copolymers with a polar vinyl monomer are undesirable because they increase the dielectric loss tangent.

Usable non-polar α-olefin monomers include ethylene, propylene, butene-1, hexene-1, octene-1 and 4-methylpentene-1. Among these, ethylene, propylene, butene-1 and 4-methylpentene-1 are preferred because of providing a non-polar α-olefin base polymer having a low-dielectric constant.

Examples of the non-polar α-olefin base (co)polymers include low-density polyethylene, ultra-low-density polyethylene, very-ultra-low-density polyethylene, high-density polyethylene, low-molecular-weight polyethylene, ultra-high-molecular-weight polyethylene, ethylene-propylene copolymer, polypropylene, polybutene, and poly(4-methylpentene). These non-polar a-olefin base (co)polymers may be used alone or in admixture of two or more.

A non-polar α-olefin base (co)polymer used in the present invention should preferably have a weight-average absolute molecular weight of at least 1,000. The upper limit of the weight-average absolute molecular weight is not particularly defined but is generally about 10,000,000.

On the other hand, the vinyl aromatic base polymer that is one segment in the thermoplastic resin exhibiting a. specific muitiphase structure should be nonpolar. Examples include (co)polymers of monomers such as styrene, nucleus-substituted styrene, e.g., methylstyrene, dimethylstyrene, ethylstyrene, isopropylstyrene, and chlorostyrene, and α-substituted styrene, e.g., α-methylstyrene, α-ethylstyrene, and o-, m-, and p-divinylbenzene (preferably m-divinylbenzene and p-divinylbenzene, and more preferably p-divinylbenzene). Nonpolar polymers are used because the introduction of a monomer with a polar functional group by copolymerization increases the dielectric loss tangent. The vinyl aromatic base polymers may be used alone or in admixture of two or more.

Among the vinyl aromatic base polymers, a vinyl aromatic copolymer containing a monomer of divinylbenzene is preferred from the viewpoint of improved heat resistance. Examples of the divinylbenzene-containing vinyl aromatic copolymer include copolymers of monomers such as styrene, nucleus-substituted styrene, e.g., methylstyrene, dimethylstyrene, ethylstyrene, isopropylstyrene and chlorostyrene, and α-substituted styrene, e.g., α-methylstyrene and α-ethylstyrene with a divinylbenzene monomer.

Although the ratio between the divinylbenzene monomer and the vinyl aromatic monomer other than the divinylbenzene monomer is not critical, it is preferred that the divinylbenzene monomer account for at least 1% by weight of. the copolymer so as to obtain the required heat resistance to solder. While it is acceptable for the proportion of the divinylbenzene monomer to be 100% by weight, it is nevertheless preferred that the upper limit of the divinylbenzene content be 90% by weight in view of a synthesis problem.

Preferably, the vinyl aromatic base polymer that forms one segment of the thermoplastic resin having a specific multiphase structure has a weight-average absolute molecular weight of at least 1,000. The upper limit of the weight-average absolute molecular weight is not particularly defined but is generally about 10,000,000.

In the present invention, the thermoplastic resin having a specific multiphase structure comprises 5 to 95% by weight, preferably 40 to 90% by weight, and most preferably 50 to 80% by weight of the olefin base polymer. In other words, the vinyl base polymer segment accounts for 95 to 5% by weight, preferably 60 to 10% by weight, and most preferably 50 to 20% by weight of the thermoplastic resin.

When the olefin base polymer segment content of the thermoplastic resin is too low, the resultant formed article becomes undesirably brittle. When the content is too high, the adhesion of the resin to metals is undesirably degraded.

The thermoplastic resin used in the present invention should have a weight-average absolute molecular weight of at least 1,000. Although the upper limit thereto is not critical, it is usually about 10,000,000 in view of moldability.

Examples of the copolymer having a structure wherein the olefin base polymer segment and vinyl base polymer segment are chemically combined include block copolymers, and graft copolymers, among which the graft copolymers are particularly preferred by reason of ease of preparation. It is acceptable for these copolymers to include olefin base polymer and vinyl base polymer provided that they do not deviate from the characteristic features of the block and graft copolymers.

The thermoplastic resin having a specific multiphase structure used in the present invention may be prepared by either chain transfer processes or ionizing radiation irradiation processes, all of which are well known graft polymerization process. The following process is most preferable, however, for the reasons that high graft efficiency prevents the occurrence of secondary coalescence due to heat so that high performance is effectively obtainable, and that the process is simple in itself.

A detailed explanation will now be given on how to prepare the graft copolymer that is the thermoplastic resin showing a specific multi-phase structure according to the present invention.

One hundred (100) parts by weight of an olefin base polymer are suspended in water. Apart from this, 5 to 400 parts by weight of a vinyl aromatic base monomer are used to prepare a solution in which there are dissolved 0.1 to 10 parts by weight, per 100 parts by weight of the vinyl base monomer, of one or a mixture of radically polymerizable organic peroxides represented by the following general formula (1) or (2) and 0.01 to 5 parts by weight, per a total of 100 parts by weight of the vinyl monomer and radically polymerizable organic peroxide, of a radical polymerization initiator. The suspension, to which the solution is added is heated under such conditions as to prevent substantial decomposition of the radical polymerization initiator, so that the olefin base polymer is impregnated with the vinyl monomer, radically polymerizable organic peroxide and radical polymerization initiator. Then, the temperature of the aqueous suspension is elevated to copolymerize the vinyl monomer and radically polymerizable organic peroxide in the olefin copolymer, thereby obtaining a grafting precursor.

Then, the grafting precursor is kneaded in a molten state at 100 to 300° C. to obtain the graft copolymer of the invention. The graft copolymer can also be obtained by kneading a mixture of the grafting precursor with a separate olefin or vinyl base polymer in a molten state. In the present invention, the most preferable graft copolymer is obtained by kneading the grafting precursor.

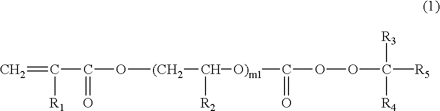

In general formula (1), R₁ is a hydrogen atom or an alkyl group having 1 to 2 carbon atoms, R₂ is a hydrogen atom or a methyl group, R₃ and R₄ are each an alkyl group having 1 to 4 carbon atoms, R₆ is an alkyl group having 1 to 12 carbon atoms, a phenyl group, an alkyl-substituted phenyl group or a cycloalkyl group having 3 to 12 carbon atoms, and m1 is 1 or 2.

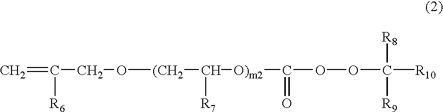

In general formula (2) R₆ is a hydrogen atom or an alkyl group having 1 to 4 carbon atoms, R₇ is a hydrogen atom or a methyl group, R₈ and R₉ are each an alkyl group having 1 to 4 carbon atoms, R₁₀ is an alkyl group having 1 to 12 carbon atoms, a phenyl group, an alkyl-substituted phenyl group or a cycloalkyl group having 3 to 12 carbon atoms, and m2 is 0, 1 or 2.

Examples of the radically polymerizable organic peroxide represented by general formula (1) include t-butyl peroxyacryloyloxyethyl carbonate, t-amyl peroxyacryloyloxyethyl carbonate, t-hexyl peroxyacryloyloxyethyl carbonate, 1,1,3,3-tetramethylbutyl peroxyacryloyloxyethyl carbonate, cumyl peroxyacryloyloxyethyl carbonate, p-isopropylcumyl peroxyacryloyloxyethyl carbonate, t-butyl peroxymethacryloyloxyethyl carbonate, t-amyl peroxymethacryloyloxyethyl carbonate, t-hexyl peroxymethacryloyloxyethyl carbonate, 1,1,3,3-tetramethylbutyl peroxymethacryloyloxyethyl carbonate, cumyl peroxymethacryloyloxyethyl carbonate, p-isopropylcumyl peroxymethacryloyloxyethyl carbonate, t-butyl peroxymethacryloyloxyethyl carbonate, t-amyl peroxyacryloyloxyethyl carbonate, t-hexyl peroxyacryloyloxyethoxyethyl carbonate, 1,1,3,3-tetramethylbutyl peroxyacryloyloxyethoxyethyl carbonate, cumyl peroxyacryloyloxyethoxyethyl carbonate, p-isopropylcumyl peroxyacryloyloxyethoxyethyl carbonate, t-butyl peroxymethacryloyloxyethoxyethyl carbonate, t-amyl peroxymethacryloyloxyethoxyethyl carbonate, t-hexyl peroxymethacryloyloxyethoxyethyl carbonate, 1,1,3,3-tetramethylbutyl peroxymethacryloyloxyethoxyethyl carbonate, cumyl peroxymethacryloyloxyethoxyethyl carbonate, p-isopropylcumyl peroxymethacryloyloxyethoxyethyl carbonate, t-butyl peroxyacryloyloxyisopropyl carbonate, t-amyl peroxyacryloyloxyisopropyl carbonate, t-hexyl peroxyacryloyloxyisopropyl carbonate, 1,1,3,3-tetramethylbutyl peroxyacryloyloxyisopropyl carbonate, cumyl peroxyacryloyloxyisopropyl carbonate, p-isopropylcumyl peroxyacryloyloxyisopropyl carbonate, t-butyl peroxymethacryloyloxyisopropyl carbonate, t-amyl peroxylmethacryloyloxyisopropyl carbonate, t-hexyl peroxylmethacryloyloxyisopropyl carbonate, 1,1,3,3-tetramethylbutyl peroxymethacryloyloxyisopropyl carbonate, cumyl peroxymethacryloyloxyisopropyl carbonate, and p-isopropylcumyl peroxymethacryloyloxyisopropyl carbonate.

Exemplary compounds represented by general formula (2) include t-butyl peroxyallyl carbonate, t-amyl peroxyallyl carbonate, t-hexyl peroxyallyl carbonate, 1,1,3,3-tetramethylbutyl peroxyallyl carbonate, p-menthane peroxylallyl carbonate, cumyl peroxylallyl carbonate, t-butyl peroxyallyl carbonate, t-amyl peroxymethallyl carbonate, t-hexyl peroxymethallyl carbonate, 1,1,3,3-tetramethylbutyl peroxymethallyl carbonate, p-menthane peroxymethallyl carbonate, cumyl peroxymethallyl carbonate, t-butyl peroxyallyoxyethyl carbonate, t-amyl peroxyallyloxyethyl carbonate, t-hexyl peroxyallyloxyethyl carbonate, t-butyl peroxymethallyloxyethyl carbonate, t-amyl peroxymethallyloxyethyl carbonate, t-hexyl peroxymethallyloxyethyl carbonate, t-butyl peroxyallyloxyisopropyl carbonate, t-amyl peroxyallyloxyisopropyl carbonate, t-hexyl peroxyallyloxyisopropyl carbonate, t-butyl peroxymethallyloxyisopropyl carbonate, t-amyl peroxymethallyloxyisopropyl carbonate, and t-hexyl peroxymethallyloxyisopropyl cabonate.

Among these, t-butyl peroxyacryloyloxyethyl carbonate, t-butyl peroxymethacryloyloxyethyl carbonate, t-butyl peroxyallyl carbonate, and t-butyl peroxymethallyl carbonate can be preferably used.

The graft efficiency of the thus obtained graft copolymer is 20 to 100% by weight. The graft efficiency can be determined from the percent extraction by solvent of an ungrafted polymer.

The graft copolymer of the non-polar O-olefin base polymer segment with the vinyl aromatic base polymer segment is preferred for the thermoplastic resin exhibiting a specific multiphase structure of the present invention. For such a graft copolymer, however, it is acceptable to use a nonpolar conjugated diene base polymer segment instead of or in addition to the non-polar α-olefin base polymer segment. The diene base polymers already mentioned can be used as this nonpolar conjugated diene base polymer, and can be used alone or in admixture of two or more.

The non-polar α-olefin base polymer in the graft copolymer may contain a conjugated diene monomer and the nonpolar conjugated diene base polymer may contain an α-olefin polymer.

Moreover, in the present invention, the obtained graft copolymer may be crosslinked with divinylbenzene or the like. From the viewpoint heat resistance, crosslinking of a divinylbenzene monomer-free graft copolymer with divinylbenzene or the like is particularly preferable.

In the present invention, it is also possible to use a block copolymer as the thermoplastic resin exhibiting a specific multiphase structure. This block copolymer can, for instance, be a block copolymer of at least one polymer of a vinyl aromatic monomer with at least one polymer of a conjugated diene. The block copolymer may be linear or be radial wherein bard and soft segments are radially combined with each other, Also, the conjugated diene-containing polymer may be either a random copolymer with a small amount of a vinyl aromatic monomer or a so-called tapered block copolymer wherein the content of the vinyl aromatic monomer in one block increases gradually.

No particular limitation is imposed on the structure of the block copolymer. The block copolymer may be any of A-B)n, (A-B)n-A, and (A, B)n-C types wherein A is a polymer of the vinyl aromatic monomer, B is a polymer of the conjugated diene, C is a coupling agent residue, and n is an integer of l or greater. A conjugated diene moiety in the block copolymer may be hydrogenated for use.

For such a block copolymer, it is acceptable to use the aforesaid non-polar α-olefin base polymer instead of or in addition to the aforesaid nonpolar conjugated diene base copolymer. Moreover, the nonpolar conjugated diene base polymer may contain an α-olefin polymer, and the non-polar α-olefin base polymer may contain a conjugated diene monomer. What was said earlier regarding the preferred quantitative ratio between the segments of the graft copolymer also applies to the block copolymer.

To improve the heat resistance of the heat-resistant, low-dielectric polymeric material, preferably the thermoplastic resin exhibiting a specific multiphase structure and more preferably the graft copolymer, of the invention, it is preferable to add thereto a non-polar α-olefin base polymer including a monomer of 4-methylpentene-1. Cases may arise in which the non-polar α-olefin base polymer including a monomer of 4-methylpentene-1 is contained in the heat-resistant, low-dielectric polymeric material of the invention without making a chemical bond thereto. In such cases, addition of a non-polar α-olefin base polymer including a monomer of 4-methylpentene-l may not be required. It may be added, however, to obtain desirable characteristics.

At least 50% by weight of the nonpolar α-olefin base copolymer including a monomer of 4-methylpentene-1 is preferably accounted for by 4-methylpentene-1. Such a nonpolar α-olefin base copolymer may further contain a conjugated diene monomer.

In particular, poly(4-methylpentene-1) that is a homopolymer consisting of units of one single monomer of 4-methylpentene-1 is preferable as the nonpolar α-olefin base copolymer including the monomer of 4-methylpentene-1.

The poly(4-methylpentene-1) is preferably a crystalline poly(4-methylpentene-1) that is an isotactic poly(4-methylpentene-1) obtained by the polymerization of 4-methylpentene-1, which is a dimer of propylene, using a Ziegler-Natta catalyst or the like.

The ratio between poly(4-methylpentene-1) and the thermoplastic resin exhibiting a specific multiphase structure is not particularly limited. To achieve the required heat resistance and adhesion to metals, however, it is preferable to use poly(4-methylpentene-1) in an amount of 10 to 90% by weight. Too little poly(4-methylpentene-1) is likely to make heat resistance to solder insufficient, and too much is likely to make adhesion to metals insufficient. The same amount of addition applies when the copolymer is used instead of poly(4-methylpentene-1).

The heat-resistant, low-dielectric polymeric material of the invention (to which the non-polar a-olefin base polymer including 4-methylpentene-1 may be added) has a softening point of 200 to 260° C. Sufficient beat resistance to solder can be obtained by making a suitable selection from within this range.

As regards the electrical performance of the heat-resistant, low-dielectric polymeric material of the invention, the dielectric constant (εr) is at least 5, and even 10 to 20, and the dielectric loss tangent (tan δ) not greater than 0.01, and usually 0.005 to 0.001, as measured in the microwave band or millimeter wave band, i.e., in the range of 500 MHz to 3 GHz, particularly 800 MHz to 2 GHz.

The insulation resistivity of the heat-resistant, low-dielectric polymeric material of the present invention is at least 2 to 5×10¹⁴ Ω·cm, as represented by volume resistivity in a normal state. In addition, the heat-resistant, low-dielectric polymeric material has excellent dielectric breakdown strength of at least 15 KV/mm, and even 18 to 30 KV/mm, and is excellent in heat resistance.

The different types of the heat-resistant, low-dielectric polymeric material can be used individually or in admixture of two or more, and can be used in a pelletized form.

As regards the electrical performance of the heat-resistant, low-dielectric polymeric material of the invention, the dielectric constant (εr) is at least 5, and even 10 to 20, and the dielectric loss tangent (tan δ) not greater than 0.01, and usually 0.005 to 0.001, as measured in the microwave band or millimeter wave band, i.e., in the range of 500 MHz to 3 GHz, particularly 800 MHz to 2 GHz.

The ceramic dielectric material used in the present invention, while not particularly limited regarding dielectric constant, dielectric tangent and Q value, preferably has a dielectric constant (εr) of at leant 10, more preferably at least 30 and further preferably 85 to 100, a dielectric loss tangent (tan δ) of preferably not greater than 0.002, and a Q value of preferably 2,500 to 20,000 at 1 GHz.

Examples of ceramic dielectric materials that can be preferably used in the invention include titanium-barium-neodymium base composite oxides, lead calcium base composite oxides, titanium dioxide base ceramics, barium titanate base ceramics, lead titanate base ceramics, strontium titanate base ceramics, calcium titanate base ceramics, bismuth titanate base ceramics, magnesium titanate base ceramics, and lead zirconate base ceramics, as well as CaWO₄ base ceramics, Ba(Mg, Nb)O₃ base ceramics, Ba(Mg, Ta)O₃ base ceramics, Ba(Co, Mg, Nb)O₃ base ceramics, and Ba(Co, Mg, Ta)O₃ base ceramic. These materials can be used singly or in admixture of two or more.

By “titanium dioxide base ceramics” is meant a system that, in terms of composition, is composed solely of titanium dioxide or further comprises titanium oxide and a small amount of other additives, and that keeps the crystal structure of its main component titanium dioxide intact. The same also holds for other ceramic systems. Titanium dioxide is a substance represented by TiO₂, and may have various crystal structures. Of these substances, however, only the titanium dioxide having a rutile structure can be used as a ceramic dielectric material.

In the present invention, the ceramic dielectric material should, with consideration to its characteristics, preferably have a grain diameter distribution range of 1 to 200 μm and an average grain diameter of 90 to 150 μm. When the grain diameter is too large, uniform dispersion and mixing of the ceramic dielectric material in and with the polymeric dielectric material becomes difficult. When it is too small, the ceramic dielectric material cannot be mixed with the polymeric material. Even if it can somehow be mixed with the polymeric material, the ceramic dielectric material grains agglomerate to form a nonuniform mixture that is difficult to handle.

In the present invention, for achieving a high dielectric constant and low dielectric tangent in the high frequency band, it is particularly preferable that a titanium-barium-neodymium base material, or a lead-calcium base material be used as the ceramic dielectric material. The content of the ceramic dielectric material in the composite dielectric material composition is preferably 50 to 95% by weight and more preferably 50 to 90% by weight and most preferably 60 to 90% by weight. A content in this range facilitates achievement of a high dielectric constant and low dielectric loss tangent. On the contrary, if the content of the ceramic dielectric material is set low, the dielectric constant tends to be low and the dielectric loss tangent high. On the other hand, an excessively high ceramic dielectric material content degrades the mechanical properties and moldability.

Such a ceramic dielectric material is obtained by firing according to known processes. Although no particular limitation is imposed on the firing conditions, it is nevertheless preferable that the firing temperature be within the range of 850 to 1,400° C.

The composite dielectric material composition of the; present invention can be obtained by hot-kneading predetermined amounts of the heat-resistant, low-dielectric polymeric material and the ceramic dielectric material. Specifically, it can be obtained by hot-blending the materials using an ordinary kneading machine such as a Banbury mixer, pressure kneader, kneading extruder, a single-twin-screw extruder or roll.

The composite dielectric material to be used in actual applications may be obtained from the composite dielectric material composition Of the invention by processes wherein the composite dielectric material composition is formed into the desired shape (e.g., a film) by heat pressing, etc. Alternatively, the composite dielectric material composition may be hot mixed with other thermoplastic resin using a molding machine that applies shear force, such as a roll mixer, Banbury mixer, kneader, or single- or twin-screw extruder, and then formed into the desired shape.

Although the dielectric layers of the dielectric multilayered substrate used in the high frequency band pass filter of the present invention are preferably made of graft polymer, the following dielectric polymeric material also can be used.

Namely, in the present invention, preferable use can be made of a dielectric polymeric material obtained by polymerizing a monomeric composition comprising a fumaric diester monomer, i.e., a fumarate polymer having recurring units derived from a fumaric diester.

The fumaric diester monomer used is not particularly limited insofar as it call form a polymer having low dielectric properties and heat resistance. However, the fumaric diester monomer is preferably one expressed by formula (1):

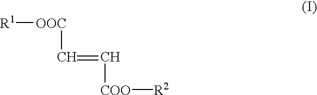

In the structural formula (I), R¹ is an alkyl or cycloalkyl group and R² is an alkyl, cycloalkyl or aryl group, and R¹ and R² may be identical or different.

The alkyl groups represented by each of R¹ and R² preferably have 2 to 12 carbon atoms in total, and may be either linear or branched and have a substituent. For substituted alkyl groups, exemplary substituents include halogen atoms such as F, and Cl, alkoxy groups such as methoxy, ethoxy, propoxy and butoxy groups, and aril groups such as phenyl.

Examples of the alkyl group represented by R¹ and R² include ethyl, n-propyl, isopropyl, n-butyl, sec-butyl, tert-butyl, n-pentyl (or n-amyl), sec-amyl, isopentyl, neopentyl, tert-pentyl, n-hexyl, 4-methyl-2-pentyl, heptyl, octyl, nonyl, decyl, undecyl, and dodecyl groups; trifluoroethyl, hexafluoroisopropyl, perfluoroisopropyl, perfluorobutylethyl, perfluorooctylethyl, and 2-chloroethyl groups; 1-butoxy-2-propyl and methoxyethyl groups; and benzyl group.

The cycloalkyl groups represented by each of R¹ and R² preferably have 3 to 14 carbon atoms in total, and may have either a single ring or a bridged ring and have a substituent. For substituted cycloalkyl groups, exemplary substituents are the same as exemplified for the substituted alkyl groups while alkyl groups (for example, linear or branched alkyl groups of 1 to 14 carbon atoms, typically methyl) are also useful substituents.

Examples of the cycloalkyl group represented by by R¹ and R² include cyclopentyl, cyclohexyl, adamantyl, and dimethyladamantyl groups.

The aryl groups represented by R² preferably have 6 to 18 carbon atoms in total. Monocyclic aryl groups are preferred although polycyclic ones (having condensed rings and individual rings) are acceptable. The aryl groups may have a substituent that is the same as exemplified for the alkyl and cycloalkyl groups.

Phenyl is typical of the aryl group represented by R².

Preferably, each of R¹ and R² is an alkyl or cycloalkyl group. The preferred alkyl groups are branched alkyl groups such as isopropyl, sec-butyl and tert-butyl groups. Cyclohexyl is the preferred cycloalkyl group.

Preferred examples of the fumaric diester monomer of formula (I) include:

dialkyl fumarates such as diethyl fumarate, di-n-propyl fumarate, di-n-hexyl fumarate, isopropyl n-hexyl fumarate, diisopropyl fumarate, di-n-butyl fumarate, di-sec-butyl fumarate, di-tert-butyl fumarate, di-sec-amyl fumarate, n-butyl isopropyl fumarate, isopropyl see-butyl fumarate, tert-butyl 4-methyl-2-pentyl fumarate, isopropyl tert-butyl fumarate, isopropyl sec-amyl fumarate, di-4-methyl-2-pentyl fumarate, diisoamyl fumarate, di-4-methyl-2-hexyl fumarate, and tert-butyl isoamyl fumarate;

dicycloalkyl fumarates such as dicyclopentyl fumarate, dicyclohexyl fumarate, dicycloheptyl fumarate, cyclopentylcyclohexyl fumarate, bis(dimethyladamantyl) fumarate, and bis(adamantyl) fumarate;

alkyl cycloalkyl fumarates such as isopropyl cyclohexyl fumarate, isopropyl dimethyladamantyl fumarate, isopropyl adamantyl fumarate, and tert-butyl cyclohexyl fumarate;

alkyl aryl fumarates such as isopropyl phenyl fumarate;

alkyl aralkyl fumarates such as tert-butyl benzyl fumarate and isopropyl benzyl fumarate;

di-fluoroalkyl fumarates such as ditrifluoroethyl fumarate; dihexafluoroisopropyl fumarate, diperfluoroisopropyl fumarate, and bis(perfluorobutylethyl) fumarate;

alkyl fluoroalkyl fumarates such as isopropyl perfluorooctylethyl fumarate and isopropyl hexafluoroisopropyl fumarate; and

other substituted alkyl alkyl fumarates such as 1-butoxy-2-propyl tert-butyl fumarate, methoxyethyl isopropyl fumarate and 2-chloroethyl isopropyl fumarate.

Especially preferred among others are diisopropyl fumarate, dicyclohexyl fumarate, di-sec-butyl fumarate, di-tert-butyl fumarate, isopropyl tert-butyl fumarate, n-butyl isopropyl fumarate, and n-hexyl isopropyl fumarate.

These diester groups can be synthesized by combining ordinary esterification and isomerization techniques.

In preparing a fumarate polymer constituting a dielectric polymeric material, the fumaric diesters (fumarates) mentioned above may be used alone or in admixture of two or more. Accordingly, the fumarate polymer according to the invention may be either a homopolymer obtained by polymerizing a single fumaric diester or a copolymer obtained by polymerizing two or more fumaric diesters. The copolymers may be random, alternating or block copolymers.

Although the fumarate polymer according to the invention may thus be one obtained using only a fumaric diester as a monomer as mentioned above, monomers other than the fumaric diester may be used in polymerization, That is, copolymers of the fumaric diester with another monomer or monomers are also acceptable. The other monomer is typically a vinyl monomer. The vinyl monomer used herein as a comonomer is not particularly limited insofar as it is copolymerizable with the fumarate and imparts moldability, film formability and mechanical strength. Preferred are vinyl monomers of the following

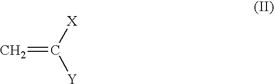

general formula (II):

In structural formula (II), X is a hydrogen atom or methyl group and Y is selected from the class consisting of a fluorine atom, chlorine atom, alkyl group, alkenyl group, aryl group, ether group, acyl group, and ester group.

The alkyl group represented by Y preferably has 1 to 14 carbon atoms in total, and may be either linear or branched.

The alkenyl group represented by Y preferably has 2 to 14 carbon atoms in total, and may be either linear or branched. For substituted alkenyl groups, exemplary substituents are vinyl, allyl, propenyl and butenyl groups.

The aryl group represented by Y preferably has 6 to 18 carbon atoms in total, and may be either monocyclic or polycyclic such as a condensed ring. The aryl group may have a substituent, for example, halogen atoms such as F and Cl and alkyl groups such as methyl. Exemplary of the aryl group are phenyl, α-naphthyl, β-naphthyl, o-, m- and p-tolyl, and o-, m- and p-chlorophenyl groups.

The ether group represented by Y is —OR₃, wherein R₃ is an alkyl or aryl group. The alkyl group represented by —OR₃ preferably has 1 to 8 carbon atoms in total, and may be either linear or branched and have a substituent such as halogen atoms. The aryl group represented by R₃ preferably has 6 to 8 carbon atoms in total and may be either monocyclic (preferred) or polycyclic such as a condensed ring.

Examples of the ether group represented by Y include methoxy, ethoxy, propoxy, butoxy, isobutoxy, and phenoxy groups.

The acyl group represented by Y is —COR₄, wherein R₄ is an alkyl or aryl group. The alkyl group represented by R₄ preferably has 1 to 8 carbon atoms in total, and may be either linear or branched and have a substituent such as halogen atoms. The aryl group represented by R₄ preferably has 6 to 18 carbon atoms in total and may be either monocyclic (preferred) or polycyclic such as a condensed ring.

Examples of the acyl group represented by Y include acetyl, propionyl, butyryl, isobutyryl, and benzoyl groups.

The ester group represented by Y is —OCOR₅ or —COO R₅, wherein R₅ is an alkyl or aryl group. The alkyl group represented by R₅ preferably has 1 to 20 carbon atoms in total, and may be either linear or branched and have a substituent such as halogen atoms. The aryl group represented by R₆ preferably has 6 to 18 carbon atoms in total and may be either monocyclic (preferred) or polycyclic such as a condensed ring.

Examples of the ester group represented by Y include acetoxy, propionyloxy, butyryloxy, isobutyryloxy, valeryloxy, isovaleryloxy, —OCOC₄H₉(-sec), —OCOC₄H₉(-tert), —OCOC(CH₃)₂CH₂CH₃, —OCOC(CH₃)₂CH₂CH₂CH₃, stearoyloxy, benzoyloxy, tert-butylbenzoyloxy, methoxycarbonyl, ethoxycarbonyl, butoxycarbonyl, 2-ethylhexyloxycarbonyl, and phenoxycarbonyl groups.

In the present invention, the copolymer constituent used for the dielectric polymeric material vinyl base comonomer having an olefinic hydrocarbon as the main component. Examples of the vinyl monomer of formula (II) are well-known radical polymerizable monomers including:

vinyl carboxylates such as vinyl acetate, vinyl pivalate, vinyl 2,2-dimethylbutyrate, vinyl 2,2-dimethylpentanoate, vinyl 2-methyl-2-butyrate, vinyl propionate, vinyl stearate, and vinyl 2-ethyl-2-methylbutyrate;

aromatic vinyl monomers such as vinyl p-tert-butylbenzoate, vinyl N,N-dimethylaminobenzoate, and vinyl benzoate;

styrene, o-, m- and p-chloromethylstyrene, and α-substituted styrene derivatives such as α-methylstyrene and substituted aromatic ring styrene derivatives;

alkyl-substituted aromatic ring styrenes such as o-, m- and p-methylstyrene;

α-olefins such as vinyl chloride and vinyl fluoride;

halogen-substituted aromatic ring styrenes such as o-, m- and p-halogenated styrene, typically p-chlorostyrene;

vinyl ethers such as ethyl vinyl ether, vinyl butyl ether and isobutyl vinyl ether;

naphthalene derivatives such as α-, β-vinylnaphthalene;

alkyl vinyl ketones such as methyl vinyl ketone and isobutyl vinyl ketone;

dienes such as butadiene and isoprene; and

(meth)acrylates such as methyl (meth)acrylate, ethyl (meth)acrylate, butyl (meth)acrylate, 2-ethylhexyl (meth)acrylate, and phenyl (meth)acrylate.

Such a vinyl monomer may be readily prepared by effecting ester exchange reaction between vinyl acetate and a corresponding organic acid in the presence of mercury acetate or sulfuric acid or in the presence of another catalyst, for example, metal complexes such as platinum and rhodium complexes.

In the present invention, the above-mentioned vinyl monomers may be used as a comonomer alone or in admixture of two or more.

The fumarate polymer of the invention having recurring units derived from such a vinyl monomer is a copolymer that may be a random, alternating or block copolymer.

The polymeric materials having recurring units derived from a fumaric diester described in the foregoing are low in dielectric constant and excellent in film formability, film adherence, and mechanical properties. As mentioned above, the polymeric materials may be any of a homopolymer of a single fumaric diester, a copolymer of different fumaric diesters, and a copolymer of a fumaric diester with a copolymerizable vinyl monomer.

No particular limit is imposed on the molecular weight of the fumarate polymer. When, for instance, an electrically insulating film is formed from the fumarate polymer and an electrically insulating substrate is further formed by stacking plural sections of the film, the substrate must have sufficient mechanical strength to withstand considerable stresses developed during manufacture of electronic components. With such an application taken into account, the fumarate polymer should desirably have a high molecular weight, specifically a number average molecular weight of about 10,000 to 1,500,000. Polymers with a lower molecular weight would be poor in mechanical strength, chemical stability and heat resistance. For film formation, film adherence to a substrate, and elimination of film defects, the molecular weight should be as high as practical. However, a polymer with an extremely high molecular weight would be inefficient to work or process because formation of a uniform smooth film would be difficult.

The dielectric polymeric material of the invention is obtained by polymerizing a monomeric composition containing substantially only a fumaric diester (as defined above) as a monomer or a monomeric composition further containing a vinyl monomer (as defined above) as an additional monomer.

Preferably the fumaric diester accounts for at least 50% by weight, more preferably at least 60% by weight, most preferably at least 80% by weight of the total of all monomers (entire monomer stock). A lower content of the fumaric diester would result in insufficient electrical properties (dielectric constant and dielectric loss tangent) and heat resistance.

On the other hand, the proportion of the vinyl monomer in the entire monomer stock is preferably 0 to 50% by weight, more preferably 0 to 40% by weight, most preferably 0 to 20% by weight from the standpoints of low dielectric properties (low dielectric constant and low dielectric tangent), moldability, workability, solution viscosity, film adherence, and mechanical properties.

As a consequence, the fumarate polymer should preferably contain at least 50%, more preferably at least 60%, most preferably at least 80% by weight of a component originating from the fumaric diester.

The fumarate polymer used in the invention has a softening temperature of at least 200 C, typically in the range of 230 to 350° C. Such a high softening temperature offers sufficient heat resistance in the soldering step essentially involved in a device manufacturing process. This high softening temperature of the fumarate polymer is thought to be attributable to the fact that the polymer's backbone structure is free of a methylene group and a substituent is attached to carbon in the backbone to restrain molecular chain thermal mobility of the backbone.

The fumarate polymer used in the invention is a rigid polymer having a rod-like structure. The polymer is therefore strong against attack to side chain links and excellent in heat resistance and acid and alkali resistance (etching resistance).

Preferred examples of the fumarate polymer used in the invention are given below. Each polymer is represented by its starting monomer or monomers.

I) Di-alkyl fumarate polymers

I-1: diisopropyl fumarate

I-2: dicyclohexyl fumarate

I-3: di-sec-butyl fumarate

I-4: di-tert-butyl fumarate

I-5: tert-butyl isopropyl fumarate

I-6: diisopropyl fumarate/di-sec-butyl fumarate

I-7: tert-butyl isopropyl fumarate/diisopropyl fumarate

I-8: diisopropyl fumarate/dicyclohexyl fumarate

I-9: diisopropyl fumarate/n-butyl isopropyl fumarate

I-10: diisopropyl fumarate/n-hexyl isopropyl fumarate

I-11: dicyclohexyl fumarate/n-butyl isopropyl fumarate

I-12: dicyclohexyl fumarate/di-sec-butyl fumarate

II) Di-alkyl fumarate/vinyl polymers

II-1: diisopropyl fumarate/styrene

II-2: di-sec-butyl fumarate/vinyl tert-butylbenzoate

II-3: dicyclohexyl fumarate/vinyl 2-ethyl-2-methylbutyrate

II-4: diisopropyl fumarate/vinyl tert-butylbenzoate

II-5: diisopropyl fumarate/vinyl p-N,N-dimethylaminobenzoate

II-6: dicyclohexyl fumarate/vinyl tert-butylbenzoate

II-7: cyclohexyl isopropyl fumarate/vinyl acetate

II-8: di-tert-butyl fumarate/dicyclohexyl fumarate/vinyl tert-butylbenzoate

II-9: diisopropyl fumarate/dicyclohexyl fumarate/vinyl 2-ethyl-2-methylbutyrate

II-10: diisopropyl fumarate/di-sec-butyl fumarate/vinyl N,N-dimethylaminobenzoate

II-11: di-sec-butyl fumarate/dicyclohexyl fumarate/vinyl tert-butylbenzoate

II-12: dicyclohexyl fumarate/diisopropyl fumarate/styrene

In the practice of the invention, the fumarate polymer can be preferably prepared by a conventional radical polymerization process. In order to icrease the molecular weight, the initiator used for polymerization is selected from among one or more organic peroxides and azo-compounds having a 10-hour half-life temperature of up to 80 C. Examples of the polymerization initiator include organic peroxides such as benzoyl peroxide, diisopropyl peroxydicarbonate, tert-butyl peroxydi-2-ethylhexanoate, tert-butyl peroxydiisobutyrate, cumene peroxide, tert-butyl hydroperoxide, tert-butyl peroxypivalate, and lauroyldiacyl peroxide; and azo-compounds such as 2,2′-azobisisobutyronitrile, 2,2′-azobis(2-methylbutyronitrile), azobis(2,4-dimethylvaleronitrile), 1,1′-azobis(cyclohexane-1-carbonitrile), dimethyl 2,2′-azobis(isobutyrate), 2,2′-azobis(2-4-dimethylvaleronitrile), and tert-butylperoxyisopropyl carbonate. The polymerization initiator is preferably used in an amount of up to 10 parts, more preferably up to 5 parts by weight, per 100 parts by weight of the monomer(s).

As regards the conditions under which a monomer is polymerized or monomers are copolymerized by such a process, the polymerization system is preferably kept in an inert gas atmosphere such as nitrogen, carbon dioxide, helium, and argon or under deaerated conditions. The polymerizing or copolymerizing temperature is preferably in the range of 30 to 120° C., although it varies with the particular type of polymerization initiator used, The overall time taken for polymerization is desirably about 10 to 72 hours. It is also possible to effect polymerization with additives such as pigments and UV stabilizers added to the monomer or monomers.

In the case of radical polymerization, a choice may be made among a large number of different techniques used for radical polymerization of common vinyl monomers, such as solution polymerization, bulk polymerization, emulsion polymerization, suspension polymerization, and radiation polymerization. In the present invention, which is directed to applications in high frequency bands, a key objective regarding electrical properties of low dielectric electrically insulating substrates is to minimize dielectric lose tangent. Since the presence of a low molecular weight fraction in a polymeric material can be a critical factor that induces external plasticization to increase the dielectric loss tangent and degrade dielectric characteristics in a high frequency band, it is important to employ such a polymerization technique that enables the resulting fumarate polymer or copolymer to have a very high molecular weight. Bulk polymerization and suspension-polymerization techniques are most desirable since they allow the monomer(s) to be charged in a high concentration; for example, allow a fumaric diester and a vinyl monomer, which are monomers to be charged for copolymerization, to be charged in a high concentration. Since the molecular weight of a polymer or copolymer decreases as the polymerization temperature rises, it is preferable to effect radical polymerization or copolymerization at relatively low temperatures of 0 C to 60° C.

Fumarate polymers according to the invention can be identified by nuclear magnetic resonance (NMR) spectroscopy and infrared (IR) absorption spectroscopy.

A variety of groups may be introduced as a terminal group in accordance with the intended application.

In the present invention, the fumarate polymer can be used together with a ceramic dielectric material.

The ceramic dielectric material is selected from among those explained earlier. The content of such a preferred ceramic dielectric material in the composite dielectric material composition is preferably 50 to 95%, more preferably 50 to 90%, and the most preferably 60 or 85% by weight. Use of the ceramic dielectric material at such a content makes it easy to obtain a high dielectric constant and low dielectric loss tangent. If a low content of the ceramic dielectric material is adopted, the dielectric loss tangent tends to be high because the dielectric constant becomes low. If the content of the ceramic dielectric material is too high, the mechanical properties and moldability are degraded.

In the present invention, conductive layers provided on, between or within the dielectric layers can be formed of metals such as gold, silver, copper, nickel, chromium, titanium, and aluminum, in the form of simple substances or as components of alloys. Ordinarily, a dielectric layer is fabricated by an injection fabrication with casting a formed conductive layer (conductive sheet) by etching, pressing, etc. or by placing a conductive substrate pattern on the resin substrate formed by the printing method, whereafter another dielectric layer is formed on top of the first. Otherwise the conductive layers can be formed by adhering or fusing metal conductive films on the dielectric layers or by a vapor deposition method like vacuum evaporation or sputtering or a wet plating method. The formed conductive layers are patterned as desired (by either a wet or dry method) to obtain the device pattern. In this case, good adhesion with a metal conductive film is obtained by using a dielectric layer of the present invention. The thickness of the dielectric layers, while depending on the method of formation, is preferably 50 to 1,000 μm, more preferably 100 to 800 μm, and the most preferably 200 to 500 μm. The thickness of the metal conductive film is preferably 10 to 70 μm, more preferable 18 to 35 μm. When necessary, through holes can be formed and their inner surfaces metallized by plating or the like.

In addition, patterning of the conductive layer can be achieved by patterning the metal conductive film beforehand and adhering the patterned film to the dielectric layer. When metal conductive films and dielectric layers are adhered by stacking, however, the outermost metal conductive layer can either be patterned first and then adhered or be adhered first and then patterned by etching.

The use frequency band of the high frequency band pass filter of the present invention is preferably 500 MHz to 3 GHz and more preferably 800 MHz to 2 GHz.

A high frequency band pass filter that is a preferred embodiment of the present invention will now be explained in detail with reference to the drawings.

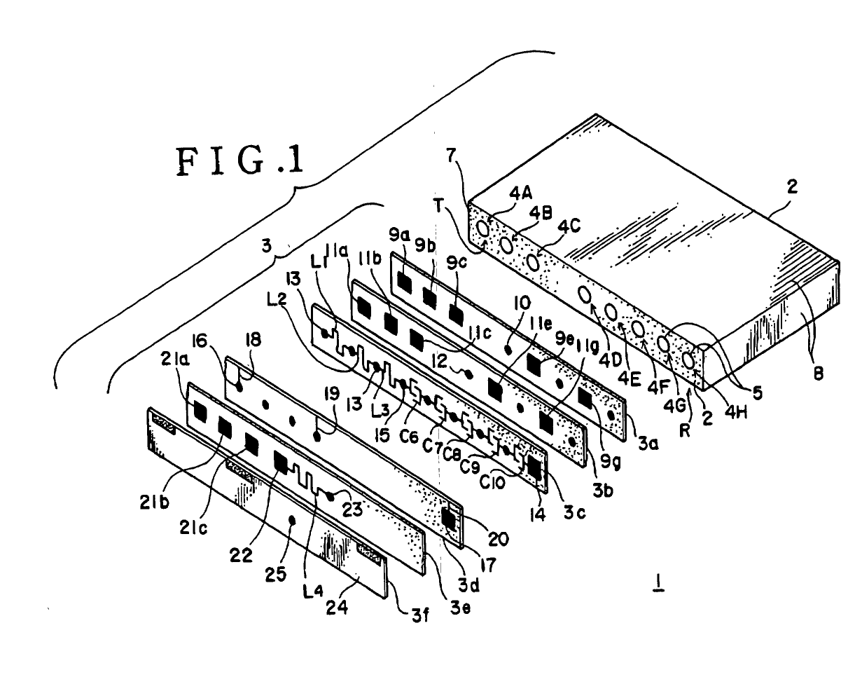

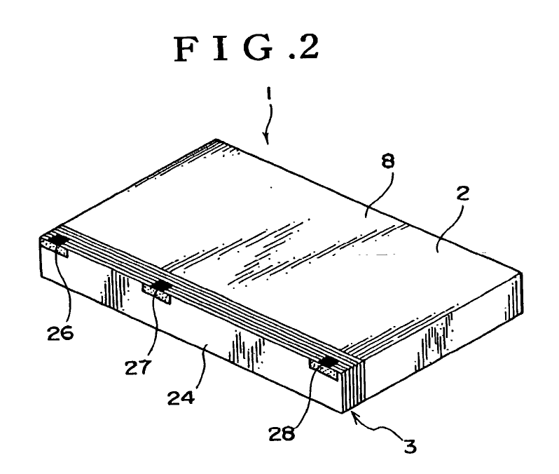

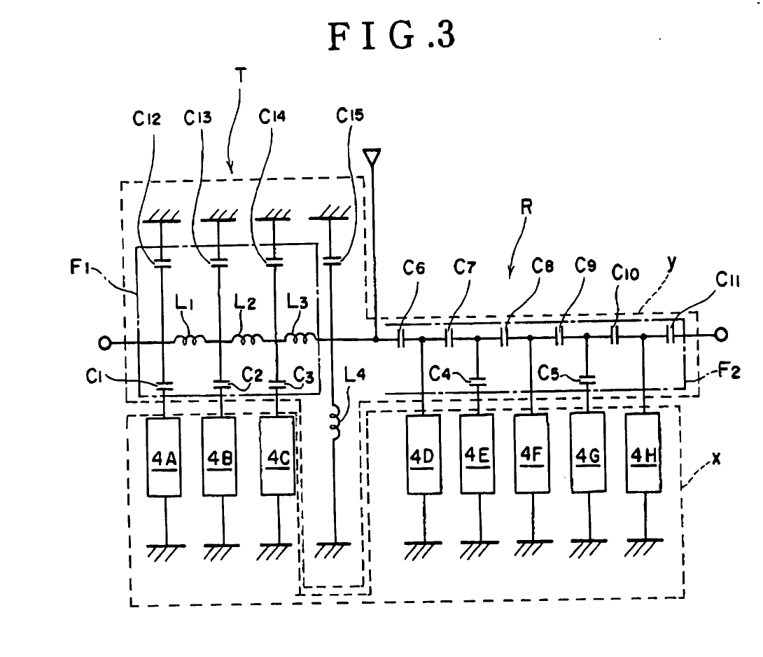

FIG. 1 is an exploded schematic perspective view showing a high frequency band pass filter that is a preferred embodiment of the present invention. FIG. 2 is a schematic perspective view showing the high frequency band pass filter with its components joined. FIG. 3 is an equivalent circuit diagram of the filter shown in FIGS. 1 and 2.

As shown in FIG. 1, the high frequency band pass filter 1 of this embodiment is constituted of a dielectric block 2 made of sintered dielectric ceramic material, such as a barium-titanate base ceramic, and a laminated circuit body 3, which together establish the circuit shown in FIG. 3.

The dielectric block 2 has eight resonators 4A to 4H that can be divided into a group composed of three resonators 4A, 4B, and 4C, and a group composed of five resonators 4D to 4H. The group composed of the three resonators 4A, 4B, and 4C among the eight resonators constitutes a transmitter section T shown in FIG. 3, and the group composed of the five resonators 4D to 4H constitutes a receiver section R shown in FIG. 3.

The resonators 4A to 4C constituting the transmitter section T and the resonators 4D to 4H constituting the receiver section R are formed to lie in parallel in the same direction relative to the dielectric block 2. The resonators 4A to 4H are formed by through holes 5 having inner surfaces coated with conductors 6. Further, a ground conductor 8 is formed on all surfaces of the dielectric block 2 except an open surface 7, the surface in which the holes 5 are formed. The length of each resonator 4A to 4H is substantially the same as the length corresponding to ¼ of the resonance frequency λ. The resonators 4A to 4H constitute the resonator circuit designated X in FIG. 3.

The laminated circuit body 3 is joined to the open surface 7 of the dielectric block 2.

The laminated circuit body 3 is formed by laminating dielectric layers 3a to 3f that have the same rectangular shape and size as the open surface 7 to form a multilayered substrate. The dielectric layers 3a to 3f are made of a composite dielectric material composition containing a ceramic dielectric material a heat-resistant, low-dielectric polymeric material including one or more resins whose weight-average absolute molecular weight is at least 1,000 and wherein the sum of carbon atoms and hydrogen atoms thereof is at least 99% of all atoms and some or all resin molecules have a chemical bond therebetween.

As shown in FIG. 3, the dielectric layers 3a-3f, by their lamination, form in the laminated circuit body 3 an LC coupling circuit Y equipped with a band elimination filter subcircuit F1 and a band pass filter subcircuit F2.

The laminated circuit body 3 is constituted as a single chip obtained by laminating the dielectric layers 3a-3f into a multilayered substrate. The high frequency band pass filter 1 can therefore be easily fabricated to have the neat, overall shape of a rectangular prism simply by joining the laminated circuit body 3 to the open surface 7.

Each dielectric layer 3a to 3f is formed with patterned conductors of prescribed configuration and through holes.

Specifically, the dielectric layer 3a is formed with through holes (not shown) at locations opposite the resonators 4A, 4B, 4C, 4E, and 4G so as to connect the resonators with electrodes 9a, 9b, 9c, 9e, and 9g formed on the upper surface of the dielectric layer 3a. The dielectric layer 3a is further formed with through holes 10 at locations opposite the resonators 4D, 4F and 4H.

The dielectric layer 3b is formed with electrodes 11a, 11b, 11c 11e, and 11g at locations on its upper surface opposite the electrodes 9a, 9b, 9c, 9e, and 9g and with through holes 12 at location opposite the resonators 4D, 4F, and 4H.

Thus, capacitors C1, C2, and C3, whose capacitance is determined by the thickness and dielectric constant of the dielectric layer 3b and the areas-of the electrodes 9a, 9b, 9c, 11a, 11b, and 11c, are formed between the resonators 8A to 4C and the electrodes 11a, 11b, and 11c. The capacitors C1, C2, and C3 are part of the band elimination filter subcircuit F1 shown in FIG. 3. Similarly, capacitors C4 and C5, whose capacitance is determined by the thickness and dielectric constant of dielectric layer 3b and the areas of the electrodes 9e, 9g, 11e, and 11g, are formed between the resonators 4E and 4G and the electrodes 11e and 11g. The capacitors C4 and C5 are part of the band pass filter subcircuit F2 shown in FIG. 3.

Further, the dielectric layer 3c has a plurality of through holes 13 connected to the electrodes 11a, 11b, 11c, 11e, and 11g and the through holes 12 formed on the dielectric layer 3b, an electrode 14 connected to a through hole (not shown) formed at a location corresponding to the resonator 4H, and a point 15 formed approximately midway between the resonators 4C and 4D. Moreover, inductors L1, L2, and L3 constituted by snaking conductive paths formed between the through holes 13 connected to the electrodes 11a and 11b, between the through holes 13 connected to the electrodes 11b and 11c, and between the through hole 13 to the electrodes 11c and the point 15. Comb capacitors C6 to C10 are formed between the through holes 13 formed at locations corresponding to the resonators 4D to 4G and the electrode 14. The inductors L1, L2, and L3 are part of the band elimination filter subcircuit F1 shown in FIG. 3. The capacitors C6 to C10 are part of the band path filter subcircuit F2 shown in FIG. 3.

The dielectric layer 3d is formed with through holes 16 at locations corresponding to the resonators 4A to 4C and the point 15 and with an electrode 17 at a location opposite the electrode 14. Further, dielectric layer 3d has an input lead 18 led out from the one of the through holes 16 located opposite the resonator 4A, an antenna lead 19 led out from the through hole formed at the location corresponding to the point 15, and an output lead 20 led out from the electrode 17. The electrode 14, dielectric layer 3d, and electrode 17 work as a capacitor C11 that is part of the band pass filter subcircuit F2 shown in FIG. 3.

The dielectric layer 3e has electrodes 21a to 21c connected to through holes (not shown) formed at locations corresponding to the resonators 4A to 4C, an electrode 22 connected to a through hole (not shown) formed at a location corresponding to the point 15, a point 23, and an inductor L4 constituted by a snaking conductive path formed between the electrode 22 and the point 23.

The dielectric layer 3f is formed with a ground conductor 24 over its entire front surface except at portions around the input/output terminals. Further, the dielectric layer 3f has a through hole 25 connected to the ground conductor, 24 so as to connect the point 23 formed on the dielectric layer 3e to the ground conductor 24. The ground conductor 24 opposes the electrodes 21a to 21c and the electrode 22 across the dielectric layer 3f so as to constitute capacitors C12 to C15 that are part of the band elimination filter subcircuit F1 shown in FIG. 3.

After the dielectric layers 3a to 3f configured as described above have been laminated to form the laminated circuit body 3. The upper surface of the laminated circuit body 3 is then formed with an input terminal pad 26 connected to the input lead 18, an antenna terminal pad 27 connected to the antenna lead 19, and an output terminal pad 28 connected to the output lead 20. This completes the fabrication of laminated circuit body 3.

Merely by forming the plurality of dielectric layers 3a to 3f on the open surface 7 of the dielectric block 2, therefore, it is possible to couple the band elimination filter subcircuit F1 composed of the capacitors C1, C2 and C3, the capacitors C12, C13 and C14 and the inductors L1, L2 and L3 with the resonators 4A to 4C of the transmitter section T. couple the band pass filter subcircuit F2 composed of the capacitors C4 to C11 with the resonators 4D to 4H of the receiver section R, thereby constituting the LC coupling circuit Y, and thus to configure the transducer circuit shown in FIG. 3 of the LC coupling circuit Y, the resonators 4A to 4C of the high frequency band pass filter, and the resonator circuit X composed of the resonators 4D to 4H of the receiver section R.

Conventionally, the dielectric multilayered substrate of a filter has been fabricated by a ceramic green sheet process or a printing process. In such multiple production processes, a single substrate is formed with several to several hundred (or even several thousand) of the required conductive patterns, sintered and diced (or diced and sintered). In contrast, the dielectric multilayer substrate of the high frequency band pass filter 1 according to the present invention can be fabricated by an injection fabrication with casting a formed conductive substrate by etching, pressing, etc. or by placing a conductive substrate pattern on the resin substrate formed by the printing method and forming another dielectric layer thereon. Further, the dielectric multilayer substrate can be fabricated by impregnating a glass fabric with the fumarate polymer, adhering a metal foil to the impregnated glass fabric to form a substrate material, patterning the substrate material by etching or the like, forming through holes at appropriate locations, plating the through holes, laminating the substrates, and dicing.

When a dielectric layer is fabricated using a mixed powder of fumarate or graft polymer adjusted to a dielectric constant of 10 to 20, its dielectric loss tangent is in the approximate range of 0.002 to 0.0001, which is on a par with the electrical characteristics of a ceramic. In addition, the dielectric layer is light in weight.

Since the high frequency band pass filter 1 of the present invention does not use ceramic laminated members, it is safe against interlayer shift attributable to viscosity before sintering and against occurrence of shrinkage and distortion of internal structures during sintering. In addition, dicing for obtaining discrete chips is easy.

### EXAMPLES

Examples will now be set out in order to further clarify the effect of the present invention.

Synthesis examples of the heat-resistant, low-dielectric polymeric material used in working examples will be set out first.

### Synthesis Example 1

In a stainless autoclave of 5 liters in volume, 2.5 g of a suspending agent (polyvinyl alcohol) was dissolved in 2,500 g of pure water. 700 g of an olefinic polymer (polypropylene) (product of Japan Polyolefins Co., Ltd. marketed as J Alloy 150G) was placed in the solution and dispersed by stirring.

Separately, 1.5 g of a radical polymerization initiator (benzoyl peroxide) and 9 g of a radical-polymerizable organic peroxide (t-butylperoxymethacryloyloxyethyl carbonate) was dissolved in 300 g of an vinyl aromatic monomer (styrene) to prepare another solution. This solution was charged in the autoclave and stirred with the first solution.

Next, the autoclave was brought up to a temperature of 60 to 65° C. and stirring was continued for 2 hours to impregnate the polypropylene with the vinyl monomer containing the radical polymerization initiator and radical-polymerizable organic peroxide.

The autoclave was then brought up to 80 to 85° C. and held at this temperature for 7 hours to complete the polymerization. Subsequent filtration, washing with water and drying gave a grafting precursor (a).

The grafting precursor (a) was extruded at 200° C. through a single-screw extruder (Labo Plasto Mill, product of Toyo Seiki SeiBaku-sho, Ltd.) to induce graft reaction, thereby obtaining a graft copolymer (A).

Analysis of the graft copolymer (A) by pyrolysis gas chromatography showed the weight ratio of polypropylene (PP) and styrene (St) to be 70:30.

It was also found that the graft efficiency of the styrene polymer segment was 50.1% by weight. The graft efficiency was determined by extracting ungrafted styrene polymer with ethyl acetate in a Soxhlet extractor and calculating the ratio of the ungrafted polymer to the grafted polymer.

The weight-average absolute molecular weight of the graft copolymer (A) was measured with a high-temperature GPC (Waters Corporation) and its carbon and hydrogen contents were determined by elemental analysis. The sum of carbon atoms and hydrogen atoms accounted for more than 99% of all atoms. The molecular weight of the propylene (PP) was 300,000.

The resin particles were hot-pressed at 220° C. using a hot-pressing machine (Ueshima Machine Co., Ltd.) to prepare 10 cm×10 cm×0.1 cm electrical insulating material test pieces.

Separately, an injection molding machine was used to prepare Izod impact and solder heat-resistance test pieces measuring 13 mm×130 mm×6 mm.

The obtained test pieces were used to evaluate volume resistivity, dielectric breakdown strength, dielectric constant, dielectric loss tangent, solder heat resistance, Izod impact strength, coefficient of linear expansion, and adhesion to metal.

Volume resistivity was measured by the insulation resistance test of JIS K 6911 (at a testing voltage of 500 V) and dielectric breakdown strength by the dielectric breakdown strength test of JIS C 2110.

Dielectric constant and dielectric loss tangent were measured by the cavity resonator perturbation method.

Solder heat resistance was evaluated by observing the degree of distortion a test piece experienced when immersed for 2 minutes in solder heated to 200° C., 230° C., or 260° C. Izod impact strength was measured by the (notched) Izod impact test of JIS K7110.

Coefficient of linear expansion was determined based on test piece expansion along the X and Y axes under load of 2 g in the temperature range of −30 to 130° C. Adhesion to metal was evaluated by vacuum-depositing a thin film of aluminum on a test piece and then checking the adhesion of the thin film by rubbing it lightly with a cloth.

The results of the tests are reported in Table 1. In Table 1, the dielectric constant is given as the ratio of the electrostatic capacity between the cases of using a test piece and a vacuum as dielectric.

Further, the obtained resin pellet was used for the measurement of water absorption in accordance with ASTM D570. Further, 1 g of resin pressed and heat-crosslinked by the hot-pressing machine was pulverized, placed in 70 ml of xylene, heated to 120 C under circulation and stirred for 10 min, and the degree of crosslinking was then determined from the observed resin solubility.

The results of these tests are also shown in Table 1.

### Synthesis Example 2

In a stainless autoclave of 5 liters in volume, 2.5 g of a suspending agent (polyvinyl alcohol) was dissolved in 2,500 g of pure water. 700 g of an olefinic polymer (polypropylene) (product of Japan Polyolefins Co., Ltd. marketed as J Alloy 150G) was placed in the solution and dispersed by stirring.

Separately, 1.5 g of a radical polymerization initiator (benzoyl peroxide) and 6 g of a radical-polymerizable organic peroxide (t-butylperoxymethacryloyloxyethyl carbonate) was dissolved in a mixed solution of 100 g of divinylbenzene and 200 g of a vinyl aromatic monomer (styrene) to prepare another solution. This solution was charged in the autoclave and stirred with the first solution.

Next, the autoclave was brought up to a temperature of 60 to 65 C and stirring was continued for 2 hours to impregnate the polypropylene with the vinyl monomers containing the radical polymerization initiator and radical-polymerizable organic peroxide.

The autoclave was then brought up to 80 to 85° C. and held at this temperature for 7 hours to complete the polymerization. Subsequent filtration, washing with water and drying gave a grafting precursor (b).

The grafting precursor (b) was extruded at 200° C. through a single-screw extruder (Labo Plasto Mill, product of Toyo Seiki Seisaku-sho, Ltd.) to induce graft reaction, thereby obtaining a graft copolymer (P).

Analysis of the graft copolymer (P) by pyrolysis gas chromatography showed that the weight ratio of polypropylene (PP), divinylbenzene (DVB) and styrene (St) to be 70:10:20.

It was also found that the graft efficiency of the divinylbenzene-styrene copolymer was 50.1% by weight.

The weight-average absolute molecular weight of the graft copolymer (P) was measured with a high-temperature GPC (Waters Corporation) and its carbon and hydrogen contents were determined by elemental analysis. The sum of carbon atoms and hydrogen atoms accounted for more than 99% of all atoms. The molecular weight of the propylene (PP) was 300,000.

Similarly to what was describe earlier with regard to Synthesis Example 1, the obtained graft copolymer (P) was used to fabricate test specimens. The specimens were subjected to the same tests. Also similarly, the water absorption was measured and crosslinking degree ascertained.

The results are shown in Table 1.

TABLE 1

| Synthesis Example | 1 | 2 |
|---|---|---|
| Graft copolymer | A | P |
| Charged composition (wt %) | PP:St | PP:DVB:St |
| | 70:30 | 70:10:20 |
| Result of composition analysis (wt %) | PP:St | PP:DVB:St |
| | 70:30 | 70:10:20 |
| Percentage of all atoms accounted for by | >99 | >99 |
| sum of hydrogen and carbon atoms | | |
| Volume resistivity (×10¹⁶ Ω · cm) | 3.1 | 3.0 |
| Dielectric breakdown strength (KV/mm) | 22 | 22 |
| Dielectric constant | | |
| 1 GHz | 2.27 | 2.37 |
| 2 GHz | 2.30 | 2.36 |
| 5 GHz | 2.30 | 2.33 |
| 10 GHz | 2.26 | 2.22 |
| Dielectric loss tangent (×10⁻³) | | |
| 1 GHz | 0.84 | 0.53 |
| 2 GHz | 0.52 | 0.57 |
| 5 GHz | 0.49 | 0.62 |
| 10 GHz | 0.48 | 0.71 |
| Solder heat resistance | | |
| 200° C. | No distortion | No distortion |
| 230° C. | No distortion | No distortion |
| 260° C. | Some | No distortion |
| | distortion | |
| Izod impact strength (kg · cm/cm²) | 9 | 9 |
| Coefficient of linear expansion (ppm/° C.) | 240 | 240 |
| Adhesion to metal | Good | Good |
| Water absorption (%) | >0.03 | >0.03 |
| Moldability | Good | Good |
| Degree of crosslinking (solubility) | Swelling | Insoluble |

### Working Example 1

The graft copolymer (P) prepared in Synthesis Example 2 and a ceramic dielectric material were supplied through a metering feeder to a co-axial twin-screw extruder with a screw diameter of 30 mm preset to a cylinder temperature of 230° C. (PCM30 Twin-Screw Extruder made by Ikegai Corporation) to hot-knead them into a composite dielectric material composition.

A titanium-barium-neodymium base ceramic material (average grain diameter of 120 μm and fired at 900° C.: ceramic 1) was used as the ceramic dielectric material.

Analysis of the composite dielectric material composition by an ashing method showed the weight ratio between the graft copolymer (P) and the ceramic dielectric material (ceramic 1) to be 15/85. (The same analysis values were obtained at charging and after preparation.) The composite dielectric material composition was hot-pressed at 220° C. and 300 kg/cm² using a hot-pressing machine (Ueshima Machine Co., Ltd.), and then cut to 1 mm×1 mm×100 mm to obtain sample No. 11.

Another sample (No. 12) was prepared in the same way to the same dimensions but using only the graft copolymer (P).

The dielectric constants (ε) and dielectric loss tangents (tan δ) of samples Nos. 11 and 12 at 1 GHz, 2 GHz and 5 GHz were measured by a perturbation method and their Q values were calculated.

The measurement results are shown in Table 2.

TABLE 2

| | Polymer P/ | | |
|---|---|---|---|
| Sample | Ceramic 1 | ε | tanδ [×10⁻³] Q |
| No. | (Weight ratio) | 1GHz/2GHz/5GHz | 1GHz/2GHz/5GHz |
| 11 | 15/85 | 11.186/11.210/11.168 | 1.035(966)/1.091 |
| | | | (917)/1.436(697) |
| 12 | 100/0 | 2.243/2.238/2.221 | 0.5785(1729)/ |
| | | | 0.5725(1748)/ |
| | | | 0.6421(1557) |

The solder heat resistance was determined by immersing the test pieces in solder heated to 260° C. for 2 minutes and observing the degree of test piece deformation. No deformation was observed-in any test piece.

The so-obtained composite dielectric material composition composed of the graft copolymer (P) and the ceramic dielectric material (ceramic 1) at the content ratio of 15/85 was processed into a sheet-like film measuring 150 mm in length, 100 mm in width and 0.5 mm in thickness.

After adherence of an 18 μm-thick copper film to serve as a conductive layer, the composite dielectric material composition film was patterned in a prescribed configuration, laminated and cut to fabricate a dielectric multilayer substrate for an antenna duplexer like that shown in FIG. 1.

The dielectric multilayered substrate obtained measured 18 mm in length, 3.6 mm in width and 0.5 mm in thickness. The corresponding dimensions of the antenna duplexer obtained were 18 mm, 9 mm and 3.8 mm.

The electrodes shown in FIG. 2 were formed on the dielectric multilayered substrate by first forming electrode bases by electroless plating and then forming the electrodes proper by copper electroplating. By this, there was obtained a high frequency band pass filter.

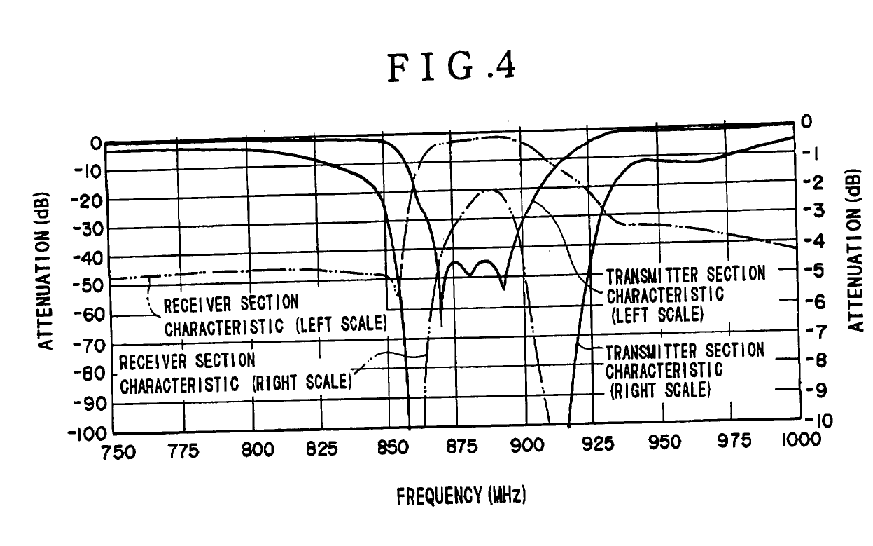

The transmission characteristic and reflection characteristic of the high frequency band pass filter in the range of 0.75 to 1 GHz were determined. The results are shown in FIG. 4.

As can be seen in FIG. 4, the high frequency band pass filter according to the present invention provides substantially the same performance as a conventional high frequency band pass filter using a ceramic.

### Working Example 2

The graft copolymer (P) prepared in Synthesis Example 2 and a ceramic dielectric material were supplied through a metering feeder to a co-axial twin-screw extruder with a screw diameter of 30 mm preset to a cylinder temperature of 230° C. (PCM30 Twin-Screw Extruder made by Ikegai Corporation) to hot-knead them into a composite dielectric material composition.

A titanium-barium-neodymium base ceramic material (average grain diameter of 120 μm and fired at 1,350° C.: ceramic 2) was used as the ceramic dielectric material.

Analysis of the composite dielectric material composition by an ashing method showed the weight ratio between the graft copolymer (P) and the ceramic dielectric material (ceramic 2) to be 15/85. (The same analysis values were obtained at charging and after preparation.) The composite dielectric material composition was hot-pressed at 220 C and 300 kg/cm² using a hot-pressing machine (Ueshima Machine Co., Ltd.), and then cut to 1 mm×1 mm×100 mm to obtain sample No. 21.

The dielectric constant (ε) and dielectric loss tangent (tan δ) of sample No. 21 at 1 GHz, 2 GHz and 5 GHz were measured by a perturbation method and its and Q value was calculated.

The measurement results are shown in Table 3.

TABLE 3

| | Polymer P/ | | |
|---|---|---|---|
| Sample | Ceramic 2 | ε | tanδ [×10⁻³] Q |
| No. | (Weight ratio) | 1GHz/2GHz/5GHz | 1GHz/2GHz/5GHz |
| 21 | 15/85 | 9.832/7.878/11.077 | 0.6621(1511)/0.6856 |
| | | | (1458)/1.0543(948) |

The solder heat resistance was determined by immersing a test piece in solder heated to 260° C. for 2 minutes and observing the degree of test piece deformation. No deformation was observed.

The so-obtained composite dielectric material composition composed of the graft copolymer (P) and the ceramic dielectric material (ceramic 2) at the content ratio of 15/85 was used to fabricate a high frequency band pass filter in the manner of Working Example 1.

The transmission characteristic and reflection characteristic of the high frequency band pass filter in the range of 0.75 to 1 GHz were determined. The results were similar to those shown in FIG. 4.

### Working Example 3

The graft copolymer (A) prepared in Synthesis Example 1 and a ceramic dielectric material were supplied through a metering feeder to a co-axial twin-screw extruder with a screw diameter of 30 mm preset to a cylinder temperature of 230° C. (PCM30 Twin-Screw Extruder made by Ikegai Corporation) to hot-knead them into a composite dielectric material composition.

As in Working Example 1, a titanium-barium-neodymium base ceramic material (average grain diameter of 120 μm and fired at 900° C.: ceramic 1) was used as the ceramic dielectric material.

Four types of the composite dielectric material composition having different blending ratios of the graft copolymer (A) and the ceramic dielectric material were prepared.

Analysis of the composite dielectric material compositions by an ashing method showed the weight ratios between the graft copolymer (A) and the ceramic dielectric material to be 15/85, 20/80 and 25/75. (The same analysis values were obtained at charging and after preparation.)

The composite dielectric material compositions were hot-pressed at 220° C. and 300 kg/cm² using a hot-pressing machine (Ueshima Machine Co., Ltd.); and then cut to-1 mm×1 mm×100 mm to obtain-samples Nos. 31 to 33.

Another sample (No. 34) was prepared in the same way to the same dimensions but using only the graft copolymer (A).

Still another sample (No. 35), measuring 1 mm×0.8 mm×100 mm, was prepared from the composite dielectric material composition obtained by hot-kneading the graft copolymer (A) and the ceramic dielectric material (ceramic 1) at a ratio by weight of 20/80.

The dielectric constants (ε) and dielectric loss tangents (tan δ) of samples Nos. 31 to 35 at 1 GHz, 2 GHz and 5 GHz were measured by a perturbation method and their and Q values were calculated.

In addition, the dielectric constants (ε), dielectric loss tangents (tan δ) and Q values of samples Nos. 34 and 35 at 10 GHz were determined in the same way.

The measurement results are shown in Table 4.

TABLE 4

| | Polymer A/ | | |
|---|---|---|---|
| | Ceramic 1 | ε | tanδ [×10⁻³] Q |
| Sample | (Weight | 1GHz/2GHz/ | 1GHz/2GHz/ |
| No. | ratio) | 5GHz/10GHz | 5GHz/10GHz |
| 31 | 15/85 | 14.4/14.4/14.3 | 2.46(408)/2.27 |
| | | | (440)/2.31(432) |
| 32 | 20/80 | 10.4/10.6/11.4 | 2.10(477)/2.07(484)/ |
| | | | 2.03(492) |
| 33 | 25/75 | 8.0/8.08/8.64 | 1.79(560)/1.76(569)/ |
| | | | 1.77(566) |
| 34 | 100/0 | 2.47/2.47/2.43/2.37 | 0.73(1377)/0.51 |
| | | | (1954)/0.56(1789)/ |
| | | | 0.66(1510) |
| 35 | 20/80 | 10.15/10.19/ | 1.92(522)/1.83(546)/ |
| | | 10.27/10.31 | 1.71(585)/2.00(500) |

The solder heat resistance was determined by immersing test pieces in solder heated to 200° C. and 230° C. for 2 minutes and observing the degree of test piece deformation. No deformation was observed in any of the test pieces.

The composite dielectric material composition composed of the graft copolymer (A) and the ceramic dielectric material (ceramic 1) at the content ratio of 15/85 was used to fabricate a high frequency band pass filter in the manner of Working Example 1.

The transmission characteristic and reflection characteristic of the high frequency band pass filter in the range of 0.75 to 1 GHz were determined. The results were similar to those shown in FIG. 4.

### Working Example 4

The graft copolymer (A) prepared in Synthesis Example 1 and a ceramic dielectric material were supplied through a metering feeder to a co-axial twin-screw extruder with a screw diameter of 30 mm preset to a cylinder temperature of 230° C. (PCM 30 Twin-Screw Extruder made by Ikegai Corporation) to hot-knead them into a composite dielectric material composition.

The same titanium-barium-neodymium base ceramic material as in Working Example 1 (average grain diameter of 120 μm and fired at 1,350° C. ceramic 2) was used as the ceramic dielectric material.

Four types of the composite dielectric material composition having different blending ratios of the graft copolymer (A) and the ceramic dielectric material (ceramic 2) were prepared.

Analysis of the composite dielectric material compositions by an ashing method showed the weight ratios between the graft copolymer (A) and the ceramic dielectric material (ceramic 2) to be 15/85, 20/80, 25/75 and 40/60. (The same analysis values were obtained at charging and after preparation.)

The composite dielectric material compositions were hot-pressed at 220° C. and 300 kg/cm² Using a hot-pressing machine (Ueshima Machine Co., Ltd.), and then cut to 1 mm×1 mm×100 mm to obtain samples Nos. 41 to 44.

The dielectric constants (ε) and dielectric loss tangents (tan δ) of samples Nos. 41 to 44 at 1 GHz, 2 GHz and 5 GHz were measured by a perturbation method and their Q values were calculated.

The measurement results are shown in Table 5.

TABLE 5

| | Polymer A/ | | |
|---|---|---|---|
| Sample | Ceramic 2 | ε | tanδ [×10⁻³] Q |
| No. | (Weight ratio) | 1GHz/2GHz/5GHz | 1GHz/2GHz/5GHz |
| 41 | 15/85 | 10.999/10.898/10.283 | 0.7346(1362)/0.8086 |
| | | | (1237)/1.074(932) |
| 42 | 20/80 | 9.395/9.160/8.638 | 0.5726(1747)/0.6388 |
| | | | (1566)/0.5773(1732) |
| 43 | 25/75 | 7.198/7.154/7.065 | 0.5783(1730)/0.6276 |
| | | | (1594)/0.7933(1261) |
| 44 | 40/60 | 4.647/4.588/4.275 | 0.6620(1511)/0.6439 |
| | | | (1544)/0.7694(1300) |

The solder heat resistance was determined by immersing test pieces in solder heated to 260° C. for 2 minutes and observing the degree of test piece deformation. No deformation was observed in any of the test pieces.

The composite dielectric material composition composed of the graft copolymer (A) and the ceramic dielectric material (ceramic 2) at the content ratio of 15/85 was used to fabricate a high frequency band pass filter in the manner of Working Example 1.

The transmission characteristic and reflection characteristic of the high frequency band pass filter in the range of 0.75 to 1 GHz were determined. The results were similar to those shown in FIG. 4.

### Working Example 5

A heat-resistant, low-dielectric polymeric material prepared by polymerizing a fumaric diester monomer composition represented by the structural formula (I) was used in place of the heat-resistant, low-dielectric polymeric materials of Working Examples 1 to 4. Each of R¹ and R² was a cyclohexyl group.

The heat-resistant, low-dielectric polymeric material composed of fumaric resin and the same ceramic dielectric material as used in Working Example 1 were supplied through a metering feeder to a co-axial twin-screw extruder with a screw diameter of 30 mm preset to a cylinder temperature of 230 C (PCM30 Twin-Screw Extruder made by Ikegai Corporation) to hot-knead them into a composite dielectric material composition that was used to fabricate a high frequency band pass filter in the manner of Working Example 1.

The transmission characteristic and reflection characteristic of the high frequency band pass filter in the range of 0.75 to 1 GHz were determined. The results were similar to those shown in FIG. 4.

The present invention has thus been shown and described with reference to specific embodiments. However, it should be noted that the present invention is in no way limited to the details of the described arrangements but changes and modifications may be made without departing from the scope of the appended claims. For example, in the embodiment illustrated in FIGS. 1 to 4, the invention was explained with reference to application to an antenna duplexer. The present invention is not limited to this application, however, but can be widely applied to high frequency band pass filters, high frequency band elimination filters and like components used in high frequency circuits.

Although embodiments were described in which a titanium-barium-neodymium base ceramic material was used as the ceramic dielectric material, the same effects can be achieved when another ceramic dielectric material is used in place of the titanium-barium-neodymium base ceramic material.

The present invention provides a high frequency band pass filter using a high frequency multilayered substrate that does not experience interlayer shift during lamination, requires only a small number of printings, does not shrink during firing, avoids distortion in the shape, thickness and spacing of substrate internal patterns and in the location of the internal pattern of the discrete devices after dicing, is free from burr occurrence, is excellent in dicing efficiency during fabrication, is superior in product yield and cost, and has enhanced performance.

1. A high frequency band pass filter comprising:
a dielectric block of substantially rectangular prismatic shape having a plurality of through holes formed from one surface thereof to another surface opposite the one surface and having metallizations formed on all outer surfaces except the one surface and all inner surfaces of the holes; and
a dielectric multilayered substrate having a plurality of dielectric layers and incorporating a capacitor and/or inductor, the dielectric multilayered substrate being made of a resin multilayered substrate,
the dielectric layers being made from a composite dielectric material composition including a ceramic dielectric material and a heat-resistant, low-dielectric polymeric material including one or more resins whose weight-average absolute molecular weight is at least 1,000 and wherein the sum of carbon atoms and hydrogen atoms is at least 99% of all atoms and some or all resin molecules have a chemical bond therebetween.

2. The high frequency band pass filter as claimed in claim 1, wherein input/output electrodes are formed on the dielectric multilayered substrate.

3. The high frequency band pass filter as claimed in claim 2, wherein the dielectric multilayered substrate is covered with metallizations formed on substantially all surfaces except a surface opposite to the dielectric block and peripheral portions of the input/output electrodes.

4. The high frequency band pass filter as claimed in claim 1, wherein the heat-resistant, low-dielectric polymeric material has at least one bond selected from among crosslinking, block and graft structure.

5. The high frequency band pass filter as claimed in claim 4, wherein the heat-resistant, low-dielectric polymeric material is a copolymer in which a nonpolar α-olefin base polymer segment and/or a nonpolar conjugated diene base polymer segment are chemically combined with a vinyl aromatic polymer segment and is a thermoplastic resin exhibiting a multiphase structure wherein a dispersion phase formed by one segment is finely dispersed in a continuous phase formed by the other segment.

6. The high frequency band pass filter as claimed in claim 5, wherein the heat-resistant, low-dielectric polymeric material is a copolymer composed of the non-polar α-olefin base polymer segment chemically combined with the vinyl aromatic polymer segment.

7. The high frequency band pass filter as claimed in claim 6, wherein the heat-resistant, low-dielectric polymeric material is a copolymer composed of 5 to 95% by weight of the non-polar α-olefin base polymer segment chemically combined with 95 to 5% by weight of the vinyl aromatic polymer segment.

8. The high frequency band pass filter as claimed in claim 7, wherein the heat-resistant, low-dielectric polymeric material is a copolymer composed of 40 to 90% by weight of the non-polar α-olefin base polymer segment chemically combined with 60 to 10% by weight of the vinyl aromatic polymer segment.

9. The high frequency band pass filter as claimed in claim 8, wherein the heat-resistant, low-dielectric polymeric material is a copolymer composed of 50 to 80% by weight of the non-polar α-olefin base polymer segment chemically combined with 50 to 20% by weight of the vinyl aromatic polymer segment.

10. The high frequency band pass filter as claimed in claim 5, wherein the vinyl aromatic polymer segment is a vinyl aromatic copolymer segment containing a monomer of divinylbenzene.

11. The high frequency band pass filter as claimed in claim 5, wherein the heat-resistant, low-dielectric polymeric material is copolymer wherein the nonpolar α-olefin base polymer segment and/or the nonpolar conjugated diene base polymer segment are chemically combined with the vinyl aromatic copolymer segment by graft polymerization.

12. The high frequency band pass filter as claimed in claim 1, wherein the heat-resistant, low-dielectric polymeric material further comprises a nonpolar α-olefin base polymer containing a monomer of 4-methylpentene-1.

13. The high frequency band pass filter as claimed in claim 1, wherein the dielectric multilayered substrate is obtained by dicing from a large multilayered body and comprises conductive layers in addition to the dielectric layers, and the heat-resistant, low-dielectric polymeric material is obtained by polymerizing a monomer composition containing as monomer at least a monomer of fumaric diester

14. The high frequency band pass filter as claimed in claim 13, wherein the fumaric diester is expressed by structural formula (I); 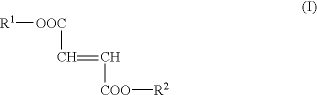
where R¹ indicates an alkyl group or a cycloalkyl group; R² indicates an alkyl group, a cycloalkyl group or an aryl group; and R¹ and R² can be the same or different.

15. The high frequency band pass filter as claimed in claim 13, wherein the monomer composition further includes a vinyl group monomer expressed by structural formula (II): 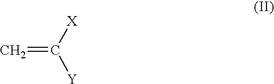
where X indicates a hydrogen atom or a methyl group; and Y indicates a fluorine atom, a chlorine atom, an alkyl group, an alkenyl group, an aryl group, an ether group, an acyl group or an ester group.
